(19) United States
(12) Patent Application Publication
(10) Pub. No.: US 2009/0320524 A1
(43) Pub. Date: Dec. 31, 2009

(54) Glass sheet cutting by laser-guided gyrotron beam

(76) Inventors: Anatoli Anatolyevich Abramov, Painted Post, NY (US); Yawei Sun, Horseheads, NY (US)

Correspondence Address: CORNING INCORPORATED, SP-TI-3-1, CORNING, NY, 14831, US

(21) Appl. No.: 12/215,510

(22) Filed: Jun. 27, 2008

(51) Int. Cl. C03B 33/09; C03B 33/02

(52) U.S. Cl. 65/112; 315/5; 65/271

(57) ABSTRACT

Disclosed are systems and methods for separating a sheet of glass by directing a microwave beam and a laser beam at a sheet of glass to propagate a crack across the sheet. A laser beam spot formed on the glass sheet by the laser at least partially overlaps a microwave beam spot produced on the sheet by the microwave beam and can be used to generate an increased power density in the overlap region, thereby forming a preferential direction for crack propagation.

### TECHNICAL FIELD

The present invention relates to systems and methods for separating glass sheets using a microwave beam and a laser beam. More specifically, systems and methods are provided for directing a microwave beam and a laser beam at a glass sheet to create thermally-induced stress differential across a thickness of the glass sheet sufficient to crack and separate the glass sheet.

### BACKGROUND

In the past, several different methods and techniques have been used to cut glass sheets. The most widely used method is mechanical scoring using a wheel made of a hard material that creates a shallow vent crack—a score line—and then breaking the glass along the score line by applying a tensile stress that grows the vent crack through the thickness of the piece. However, the mechanical scribing and breaking process can cause significant damage, both to the glass surface immediately adjacent the score line, and the edges of the glass along the break line. Additionally, the process generates debris that collects on the glass surface and requires thorough cleaning of the surface. Therefore, mechanical scribing techniques are not desirable in glass technology areas that require high glass quality, such as the liquid crystal display (LCD) industry.

Other widely used methods include the use of lasers to score and/or separate glass sheets. In one technique, a laser beam is used to score the glass; the glass is then separated by mechanical separation techniques. In another technique, the laser beam is moved across the glass sheet and creates a temperature gradient on the surface of the glass sheet, which is enhanced by a coolant (such as a gas or liquid) that follows the laser beam at some distance. Specifically the heating of the glass sheet by the laser and the cooling of the glass sheet by the coolant creates stresses in the glass sheet. In this manner, a score line is created along the glass sheet. The glass sheet can then be separated into two smaller sheets by separating the glass sheet along the score line. Yet another technique uses a first laser beam to score the glass. A second laser beam of a different configuration is used to accomplish laser separation.

In conventional laser cutting techniques, the laser beam does not penetrate deeply into the glass; some of the beam energy is reflected, while most of the beam energy is absorbed in a surface layer of the glass sheet. Further propagation of heat into the glass is achieved by thermal conduction, which is relatively slow. Thus, conventional techniques generally require several passes of the laser beam and/or slow cutting speeds to fully penetrate the glass sheet to effect separation. An “ideal” source of radiation for a full body (through the entire thickness of the glass sheet) thermally-induced cut should penetrate through the entire thickness of the glass plate, with high absorption of the radiation inside the volume of the glass to provide fast, uniform heating of the local volume. Gyrotron microwave radiation generated in a frequency range of 80-110 GHz meets these “ideal” absorption conditions. However, microwaves having a wavelength in the mm range can not be focused well enough to enable a localized heating zone, and still provide straight crack propagation.

Due to the large size of a typical microwave (gyrotron) beam power distribution, conventional microwave cutting methods are not able to produce a straight cut.

### SUMMARY

Systems and methods are provided for separating glass sheets using a relatively wide microwave beam that is guided by a laser beam or other localized heat source. This combination of two heat sources creates a stress field that induces a preferred direction of the crack propagation in a glass sheet, determined primarily by a localized heat source to enable straight separation.

In one embodiment, a system for separating a sheet of glass is described comprising a microwave beam generator for generating a microwave beam, a reflective member configured to receive the microwave beam and direct the microwave beam toward the glass sheet to create a microwave beam spot on the glass sheet, a laser configured to generate a laser beam and direct the laser beam toward the glass sheet to create a laser beam spot on the glass sheet, wherein the microwave beam spot and the laser beam spot at least partially overlap on the glass sheet, and a motion system configured to move the glass sheet or the laser beam and microwave beam relative to each other, wherein the microwave beam and laser beam create a temperature differential across a thickness of the glass sheet sufficient to crack and separate the glass sheet.

In another embodiment, a method for separating a sheet of glass is disclosed comprising forming a microwave beam, reflecting the microwave beam from a reflective member toward the glass sheet to create a substantially circular microwave beam spot focused on the glass sheet, directing a laser beam at the glass sheet to create a laser beam spot on the glass sheet, wherein the laser beam spot at least partially overlaps the microwave beam spot, and moving the glass sheet or the laser beam and microwave beam relative to each other, wherein the laser beam and microwave beam create thermally-induced stress differential across a thickness of the glass sheet sufficient to crack and separate the glass sheet.

In still another embodiment, a method for separating a glass sheet is described comprising forming a crack in the glass sheet, directing a microwave beam onto the glass sheet to create a microwave beam spot on the glass sheet, directing a laser beam onto the glass sheet to create a laser beam spot on the glass sheet, wherein a portion of the laser beam spot overlaps a portion of the microwave beam spot, developing relative motion between the glass sheet, and the laser beam and microwave beam, and wherein the laser beam spot generates an increased power density in the overlapping portion of the microwave beam spot to create a preferential direction for propagating the crack in response to the relative motion. That is, the increased power density produces a narrow region of high stress in the glass sheet that guides the propagating crack (the crack preferentially follows the region of high stress) and prevents the propagating crack from “wandering” during the propagating due to the relatively large size of the impinging microwave beam and thereby creating a separation line that deviates from the desired line.

Additional aspects of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed and/or as claimed.

### BRIEF DESCRIPTION OF THE DRAWINGS

The accompanying drawings, which are incorporated in and constitute a part of this specification illustrate various aspects of the invention and, together with the description, serve to explain the principles of the invention.

FIG. 1 illustrates an exemplary system for separating glass sheets according to embodiments of the present invention.

FIG. 2A is a diagrammatic illustration showing a laser beam spot substantially concentric with a microwave beam spot according to an embodiment of the present invention.

FIG. 2B is a diagrammatic illustration showing a laser beam spot that partially overlaps a microwave beam spot in accordance with an embodiment of the present invention.

FIG. 2C is a diagrammatic illustration showing an elongated beam spot laser beam spot that partially overlaps a microwave beam spot in accordance with an embodiment of the present invention.

FIG. 2D is a diagrammatic illustration in accordance with an embodiment of the present invention showing an elongated laser beam spot that partially overlaps a microwave beam spot and wherein a center of the elongated beam spot is coincident with a center of the microwave beam spot.

FIG. 2E is a diagrammatic illustration in accordance with an embodiment of the present invention wherein a laser beam spot is leading a microwave beam spot relative to a direction of relative motion, but wherein the laser beam spot does not overlap the microwave beam spot.

FIG. 2F is a diagrammatic illustration in accordance with an embodiment of the present invention wherein a laser beam spot is leading a microwave beam spot relative to a direction of relative motion, and wherein a center of the laser beam spot is offset from a center of the microwave beam spot in a direction that is orthogonal to the direction of relative motion between the microwave beam spot and the laser beam spot.

FIG. 3 is a plot of calculated transient stress in a glass sheet during separation in accordance with an embodiment of the present invention, wherein the gyrotron beam and the laser beam were incident on a glass sheet in a concentric arrangement.

FIG. 4 is a plot of calculated transient stress in a glass sheet during separation in accordance with an embodiment of the present invention, wherein the gyrotron beam and the laser beam were incident on a glass sheet with the center of the laser beam leading the center of the gyrotron beam by about 6 mm.

### DETAILED DESCRIPTION

The following description of the invention is provided as an enabling teaching of the invention in its best, currently known embodiment. To this end, those skilled in the relevant art will recognize and appreciate that many changes can be made to the various embodiments described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As briefly summarized above, exemplary aspects provide systems and methods for separating glass sheets using microwave beams and laser beams. An exemplary system comprises a microwave generator for generating a microwave beam, and a reflective member configured to receive the microwave beam and direct the microwave beam toward the glass sheet to create a microwave beam spot on the glass sheet. The system further comprises a laser configured to generate a laser beam and to direct the laser beam toward the glass sheet to create a laser beam spot on the glass sheet. In a further aspect, the system can comprise a motion system configured to move the glass sheet or the laser beam and microwave beam relative to each other. As described further herein below, the microwave beam and laser beam create a temperature differential across a thickness of the glass sheet, and a corresponding tensile stress, that is sufficient to propagate a crack and separate the glass sheet.

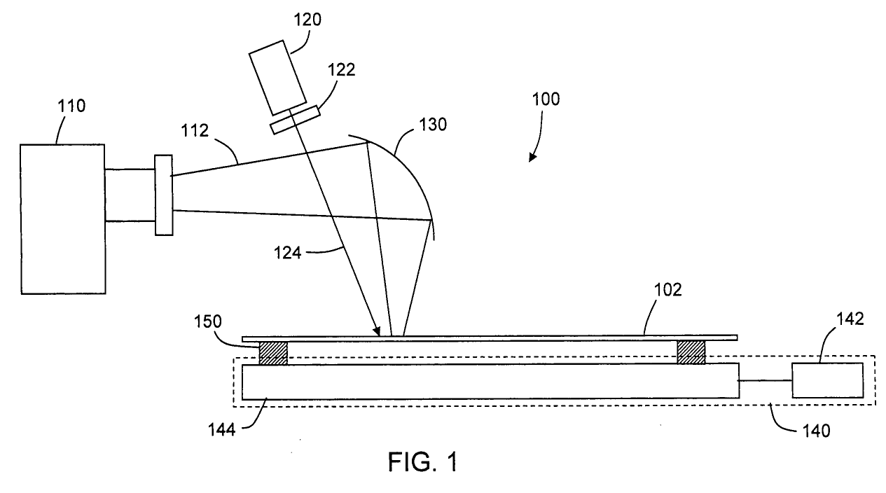

As illustrated in the embodiment of FIG. 1, system 100 comprises a microwave generator for generating a microwave beam, which can be, for example, and without limitation, a gyrotron 110, although it is contemplated different types of generators, which generate microwave radiation in a form of beam, can be used. The gyrotron 110 is configured to generate microwave beam 112. As is generally known in the art, a gyrotron generates millimeter wavelength radiation in the form of a low-divergence beam. The gyrotron, in one aspect, is configured to generate microwave radiation in a frequency range of about 80 GHz to about 110 GHz. In a particular aspect, the gyrotron generates microwave radiation having a frequency of approximately 80 GHz with a corresponding wavelength of approximately 3.6 mm. The gyrotron can further comprise a helium-nitrogen cooling system.

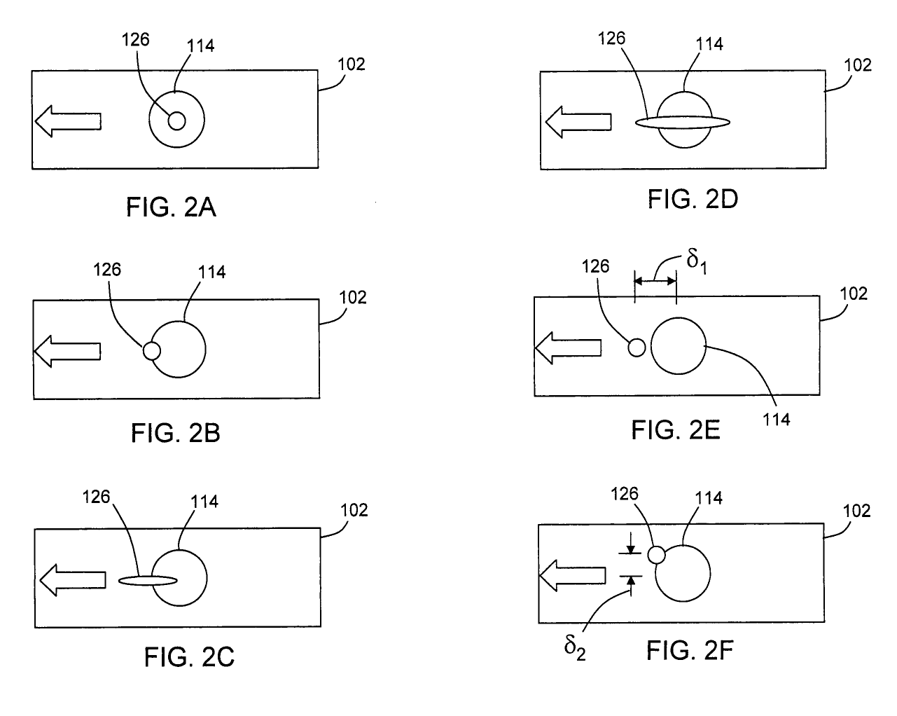

The gyrotron 110 generates a substantially circular microwave beam 112 and is configured to direct the microwave beam toward reflective member 130, such as mirror 130. Reflective member 130 is configured to receive the microwave beam and direct it toward the glass sheet to create microwave beam spot 114 on glass sheet 102, such as shown in FIGS. 2A-2F. Preferably, the microwave beam spot is substantially circular but can also have a slightly elliptical shape with longer major axis along the cutting line. The reflective member, in one aspect, can be a parabolic mirror as shown in FIG. 1. Optionally, a flat mirror can be used as the reflective member.

As described above, system 100 further comprises laser 120 configured to generate laser beam 124. System 100 may further comprise laser beam focusing and/or beam shaping optics 122. In one aspect, a CO₂ laser can be used. The laser directs the laser beam toward the glass sheet to create laser beam spot 126 on glass sheet 102, as shown in FIGS. 2A-2F. According to a particular aspect, microwave beam spot 114 and laser beam spot 126 preferably overlap on the glass sheet. That is, a portion of the laser beam spot preferably overlaps a portion of the microwave beam spot. Although the microwave beam spot and laser beam spot are described herein as being “on” the glass sheet, it is to be understood that the energy from the laser beam and the energy from the microwave beam can be at least partially absorbed within the thickness of the glass.

As shown in FIGS. 2A-2F, in one aspect microwave beam spot 114 is preferably substantially circular and has a first diameter. Likewise, laser beam spot 126 may be substantially circular and has a second diameter that is smaller than the first diameter of the microwave beam spot. Typically a microwave beam emitted from a gyrotron has a Gaussian intensity distribution, though more complex multimode intensity distributions are also possible. In theory, the beam diameter is defined as a distance between two points at which the beam intensity has fallen to 1/e² of its peak value, although the beam diameter may be estimated as a diameter of a burn mark on the surface of the material. In one aspect, the microwave beam spot has a 1/e² diameter equal to or less than about 25 mm, in the range from about 10 mm to about 25 mm, in the range from about 10 mm to about 15 mm, in the range from about 10 to about 14 mm, or in the range from about 10 to about 12 mm. In some embodiments, the laser beam incident at the glass surface has a spot diameter equal to or less than about 3 mm, preferably in the range from about 0.5 mm to about 3 mm.

In one aspect, the microwave beam spot and laser beam spot can be concentric, as shown in FIG. 2A. As shown in FIG. 2B, the laser beam spot can be offset from the microwave beam spot in the direction of travel of the microwave beam spot relative to the glass. That is, the centers of the laser beam spot and the microwave beam spot may be offset longitudinally, as indicated by the distance δ₁ in FIG. 2E. For example, the laser beam spot may be positioned at a leading edge of the microwave beam spot relative to the direction of relative motion between the glass sheet and the microwave beam spot (and laser beam spot). In a particular aspect, a center of the laser beam spot may be positioned at least about 6 mm from a center of the microwave beam spot. One skilled in the art will appreciate that the block arrows shown in FIGS. 2A-2F represent the motion of the microwave beam and laser beam relative to the motion of the glass sheet; thus, the leading edge or leading portion of the microwave beam spot is the left-most portion of the microwave beam spot when viewing FIGS. 2A-2F.

In some embodiments, the center of the laser beam spot may be offset from the center of the microwave beam spot in a direction orthogonal to the direction of travel of the microwave beam spot relative to the glass sheet, as shown in FIG. 2F. That is, the centers of the laser beam spot and the microwave beam spot may be offset laterally as indicated by the distance δ₂ in FIG. 2F. In some embodiments, the centers of the laser beam spot and the microwave beam spot may be offset both longitudinally and laterally.

In a further aspect, the system may comprise optical assembly 122, for example one or more optical lenses, that can be positioned between the laser and the glass sheet to shape the laser beam. For example, a cylindrical optical lens can be used to form an elongated (e.g. elliptical-shaped) laser beam, thereby creating an elongated (e.g. substantially elliptical) laser beam spot on the glass sheet, as shown in FIGS. 2C and 2D. As shown in FIG. 2C, in one aspect laser beam spot 126 can be positioned toward the leading edge of microwave beam spot 114. Optionally, the laser beam spot can be positioned so that a center of the laser beam spot substantially overlaps a center of the microwave beam spot, as shown in FIG. 2D. The elliptical laser beam spot, in one aspect, can have a major axis that is greater than the diameter of the microwave beam spot and a minor axis that is less than the diameter of the microwave beam spot, as exemplarily illustrated in FIG. 2D. Optionally, the center of a circular and/or elongated (e.g. elliptical) laser beam spot can be offset from the center of the microwave beam such that the laser beam spot and the microwave beam spot do not overlap, as shown in FIG. 2E

System 100 can also comprise a motion system that is configured to move the glass sheet, or the laser beam and microwave beam relative to each other. For example, in one exemplary aspect, the glass sheet can be maintained in a fixed position and the motion system can be configured to control the gyrotron and/or the reflective member to move the microwave beam relative to the glass sheet. Similarly, the motion system can be configured to control the laser to move the laser beam relative to the glass sheet. Alternatively, the microwave beam and the laser beam can be directed at the glass sheet along fixed paths, and the motion system can be configured to move the glass sheet relative to the laser beam and the microwave beam. In yet another aspect, it is contemplated that the motion system can be configured to control the gyrotron, reflective mirror, and laser to move the microwave beam and laser beam, while simultaneously moving the glass sheet.

The exemplary system illustrated in FIG. 1 comprises motion system 140 that is configured to move glass sheet 102 relative to substantially fixed microwave and laser beams. The motion system can comprise support surface 144 for supporting the glass sheet and controller 142 for controlling movement of the support surface. The support surface, in one aspect, can be a plate, such as a metal plate, that may be separated from the glass sheet by stand-offs, for example two or more quartz blocks or plates 150. The quartz bocks can be provided, for example, to increase the heating efficiency of the glass by minimizing heat dissipation that would occur in the case of direct contact between the metal plate and the glass sheet. In a further aspect, spacing the metal plate of the support surface from the glass sheet at a select distance can allow the metal plate to serve as a reflector, which can increase the intensity of a standing microwave that is created due to the interference between the transmitted microwave and the microwave reflected from the opposing metal plate surface. According to a particular aspect, the distance between the metal plate or other support surface and the closest glass surface (i.e., the lower surface of glass sheet 102 as illustrated in FIG. 1) can be selected to be equal to nλ/2, where λ is the microwave wavelength and n equal 1, 2, 3, etc. In some embodiments the support surface can be an air-bearing table.

Methods are provided for separating glass sheets using exemplary systems as described herein. In accordance with one embodiment, an initial flaw or crack may be formed in glass sheet 102, preferably at an edge of the glass sheet. A microwave beam is directed toward the glass sheet to create a microwave beam spot focused on the glass sheet. For example, as described above, gyrotron 110 can be used to generate substantially circular microwave beam 112 that is reflected from mirror 130 toward glass sheet 102 to create substantially circular microwave beam spot 114 on the sheet. The method also comprises directing a laser beam at the glass sheet to create a laser beam spot on the glass sheet.

In one aspect, the laser beam spot overlaps at least a portion of the microwave beam spot. The microwave beam provides relatively fast and uniform heating of the glass sheet and the microwave radiation is capable of penetrating the glass sheet (i.e., at least a portion of the thickness of the glass sheet proximate the microwave beam spot). The laser beam acts as a localized heat source that heats up a small size spot on the glass surface and a thin glass layer beneath the surface. The laser beam is typically (depending on the particular wavelength and optical properties of the glass) absorbed by the glass within an initial surface layer and does not penetrate deep below the surface. The combined power density of the microwave beam spot where the laser beam spot overlaps is substantially increased, thus creating a stress field in the glass that causes an initial crack to propagate through the glass sheet in a direction that is determined by the motion of the laser beam and microwave beam relative to the glass sheet and the stress field created by the combined laser beam spot and microwave beam spot. In some embodiments, an initial crack is not necessary.

As described above, in one aspect the microwave beam spot and laser beam spot are both substantially circular, and the laser beam spot has a diameter that is smaller than a diameter of the microwave beam spot, as shown in FIG. 2A and 2B. As illustrated in FIG. 2B, in one aspect of the method the center of the laser beam spot can be positioned away from the center of the microwave beam spot (such as, but not limited to, at a distance of at least about 6 mm). The laser beam spot can be positioned at the leading edge of the microwave beam spot to at least partially define the path of propagation of the crack formed in the glass sheet. Optionally and as previously described, the method can further comprise directing the laser beam through an optical lens to create a substantially elliptical laser beam spot, such as shown in FIGS. 2C and 2D.

The method further comprises moving the glass sheet or the laser beam and microwave beam relative to each other. For purposes of this description, the method will be described as moving the glass sheet relative to the laser beam and the microwave beam; however, as described above, various systems and methods for moving the glass sheet and the laser beam and microwave beam relative to each other are contemplated.

In a further aspect of the method, the microwave beam and laser beam can be directed toward the glass sheet proximate the crack. The glass sheet can then be moved to cause the crack to propagate along a predetermined path. In one aspect, the glass sheet can be moved by the motion system along a substantially linear path away from the initiated crack. Thus, as the glass sheet is moved, the crack will propagate substantially along the linear path. As described above, in some embodiments the laser beam spot is elongated. For example, the laser beam spot may be substantially elliptical. In a further aspect, the elongated laser beam spot has a major axis that is substantially parallel to and aligned with the substantially linear path along which the glass sheet is moved.

By combining the microwave beam and the laser beam, systems and methods described herein provide volumetric heating of the glass with the use of microwave radiation, and achieve precision and straightness of the crack along which the glass sheet is separated by the use of a laser beam. In other words, the laser beam spot generates an increased power density in the portion of the microwave beam spot that it overlaps. The increased power density in turn creates greater stress (than would otherwise be present based on the microwave beam spot by itself) in the glass that helps steer the crack. Thus, the laser beam, and the resulting laser beam spot, can be used to guide the crack propagation.

### EXAMPLES

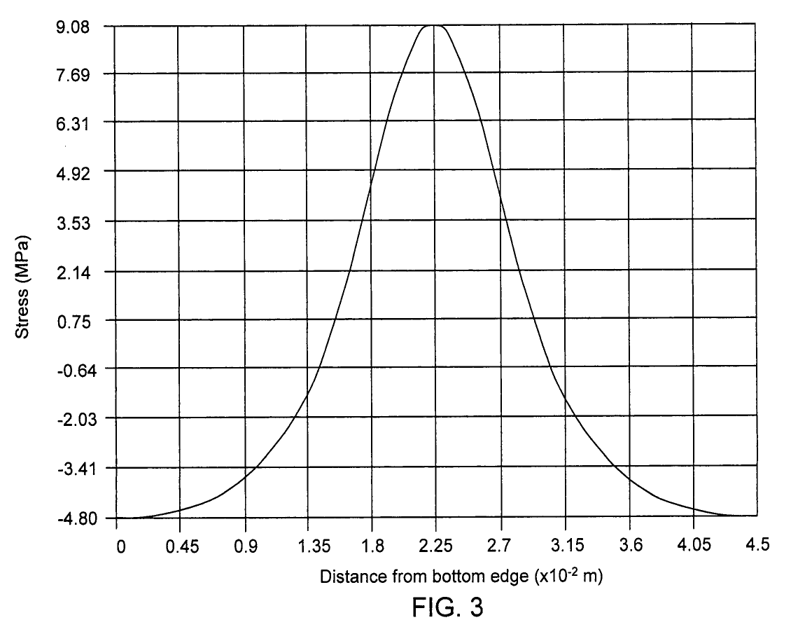

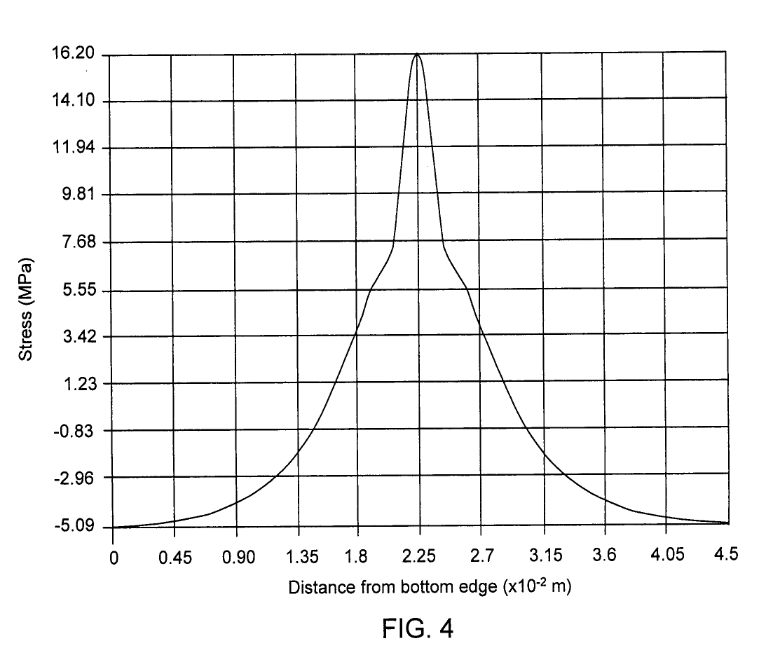

Shown in FIGS. 3 and 4 are plots of calculated transient stress (tensile) vs. position perpendicular to the direction of travel of a gyrotron beam and a laser beam over the surface of a glass sheet in accordance with an embodiment of the present invention for a concentric laser-gyrotron beam set up (FIG. 3) and for a laser beam that leads the gyrotron beam relative tom the direction of travel of the laser beam and the gyrotron beam (FIG. 4). The separation between the center of the laser beam and the center of the gyrotron beam in the latter case was about 6 mm. The gyrotron was operating at a power output of less than about 15 kW and at a frequency of about 80 MHz. The microwave beam had a Gaussian intensity distribution, and the substantially circular incidence area of the beam on the glass sheet (Corning® Eagle XG™ glass with a thickness of approximately 0.63 to 0.7 mm) had a diameter of about 10-15 mm. The laser was a CO₂ laser operating at a wavelength of 10.6 μm, a power output of less than about 100 wafts, and produced a beam with a spot diameter of about 1 mm on the surface of the glass sheet. In both plots, the X-axis denotes a perpendicular distance from the cutting line and the Y-axis denotes stress in Pascals. With regard to the X-axis, in both plots 2.25×10⁻² m denotes the position of the cutting line, i.e. the center of the stress pattern. The glass sheet was supported over a steel plate by glass blocks so that the plate was not in contact with the metal plate. The laser beam and the gyrotron were moved in unison over the surface of the glass sheet at a speed in the range between about 20 mm/s and 80 mm/s. When viewed in conjunction with Table 1 below, while the concentric beams case gave a slight increase in stress, the case involving a laser beam that leads the gyrotron beam relative to the direction of travel of the beams resulted in a significantly sharper peak transient stress proximate the cutting line when compared with FIG. 3, suggesting a more identifiable stress path for propagation of the crack (preferred propagation path), and thus a significantly straighter cut line. Table 1 provides data on the maximum temperature of the heating zone produced by the laser/gyrotron beams, and the max transient tensile stress produced during the cutting. Data for a microwave beam only is shown for reference.

TABLE 1

| | | Microwave and | |
|---|---|---|---|
| | Microwave beam | laser beam | Laser beam ahead of microwave beam |
| | only | centered (d = 0 mm) | (d = 6 mm) |
| Tₘₐₓ (° C.) | 340.0 | 637.8 | 495.6 |
| σ_{y,max} (MPa) | 8.76 | 9.08 | 16.2 |

| | |
|---|---|
| Tensile stress peaks are wide and may | Tensile stress peak is narrower and |
| result in wavy cutting edges | higher |

Lastly, it should be understood that while the present invention has been described in detail with respect to certain illustrative and specific embodiments thereof, it should not be considered limited to such, as numerous modifications are possible without departing from the broad spirit and scope of the present invention as defined in the appended claims.

1. A system for separating a glass sheet comprising:
a microwave beam generator for generating a microwave beam;
a reflective member configured to receive the microwave beam and direct the microwave beam toward the glass sheet to create a microwave beam spot on the glass sheet;
a laser configured to generate a laser beam and direct the laser beam toward the glass sheet to create a laser beam spot on the glass sheet; and
a motion system configured to move the glass sheet or the laser beam and microwave beam relative to each other, wherein the microwave beam and laser beam create a thermally-induced stress differential across a thickness of the glass sheet sufficient to crack and separate the glass sheet.

2. The system according to claim 1, wherein the laser beam spot overlaps at least a portion of the microwave beam spot.

3. The system according to claim 2, wherein the microwave beam spot has a diameter less than about 25 mm.

4. The system according to claim 2, wherein the laser beam spot has a diameter less than about 3 mm.

5. The system according to claim 1, wherein a center of the laser beam spot is positioned at least 6 mm from a center of the microwave beam spot.

6. The system according to claim 1, further comprising an optical lens positioned between the laser and the glass sheet and configured to shape the laser beam to create an elongated laser beam spot on the glass sheet that overlaps at least a portion of the microwave beam spot.

7. The system according to claim 1, wherein the microwave beam has a frequency between about 80 GHz and 110 GHz.

8. The system according to claim 1, wherein the reflective member is a flat mirror.

9. The system according to claim 1, wherein the reflective member is a parabolic mirror.

10. A method for separating a glass sheet comprising:
Directing a microwave beam onto the glass sheet to create a microwave beam spot on the glass sheet;
directing a laser beam onto the glass sheet to create a laser beam spot on the glass sheet, wherein the laser beam spot overlaps at least a portion of the microwave beam spot; and
moving the glass sheet or the laser beam and microwave beam relative to each other, wherein the laser beam and microwave beam create a thermally-induced stress differential across a thickness of the glass sheet sufficient to propagate a crack along a predetermined path and separate the glass sheet.

11. The method according to claim 10, wherein the microwave beam spot is substantially circular and has a diameter less than about 25 mm.

12. The method according to claim 11, wherein the laser beam spot is substantially circular and has a diameter less than about 3 mm.

13. The method according to claim 12, wherein a center of the laser beam spot is positioned at least 6 mm from a center of the microwave beam spot.

14. The method according to claim 10, wherein directing the laser beam onto the glass sheet comprises directing the laser beam through an optical element to create an elongated laser beam spot.

15. The method according to claim 13, wherein the center of the laser beam spot is offset laterally from the center of the microwave beam spot relative to the direction of relative motion between the microwave beam spot and the glass sheet.

16. A method for separating a glass sheet comprising:
forming a crack in the glass sheet;
directing a microwave beam onto the glass sheet to create a microwave beam spot on the glass sheet;
directing a laser beam onto the glass sheet to create a laser beam spot on the glass sheet, wherein a portion of the laser beam spot overlaps a portion of the microwave beam spot;
developing relative motion between the glass sheet, and the laser beam and microwave beam; and
wherein the laser beam spot generates an increased power density in the overlapping portion of the microwave beam spot to create a preferential direction for propagating the crack in response to the relative motion.

17. The method according to claim 16, wherein the laser beam spot is substantially circular.

18. The method according to claim 16, wherein the laser beam spot overlaps a leading edge of the microwave beam spot relative to a direction of the relative motion.

19. The method according to claim 16 wherein a center of the laser beam spot is offset from a center of the microwave beam spot in a direction orthogonal to a direction of the relative motion.

20. The method according to claim 16, wherein the laser beam spot is elongated.
